(19) United States
(12) Patent Application Publication
(10) Pub. No.: US 2011/0113286 A1
(43) Pub. Date: May 12, 2011

(54) SCAN TEST CIRCUIT AND SCAN TEST METHOD

(75) Inventors: Yukitsugu TAKASUKA, Kanagawa (JP); Masaki Asai, Kanagawa (JP)

(73) Assignee: Renesas Electronics Corporation

(21) Appl. No.: 12/941,928

(22) Filed: Nov. 8, 2010

(30) Foreign Application Priority Data
Nov. 9, 2009 (JP) 2009-256491

(51) Int. Cl. G06F 11/27

(52) U.S. Cl. 714/30; 714/E11.169

(57) ABSTRACT

A scan test circuit for a memory with a first memory cell column, a second memory cell column that replaces a failed column of the first memory cell column, a first switching circuit that connects one of the memory cell columns to a first peripheral circuit disposed at an input side, and a second switching circuit that connects one of the memory cell columns to a second peripheral circuit disposed at an output side, comprises: a test priority control circuit that controls the switching circuits to establish at least two patterns of connections of the memory cell columns to the peripheral circuits; and a test point circuit that includes scan flip-flop circuits employed in a scan test for detecting a delay fault of the peripheral circuits, and is disposed between the memory cell columns and the first switching circuit.

### REFERENCE TO RELATED APPLICATION

This application is based upon and claims the benefit of the priority of Japanese patent application No. 2009-256491, filed on Nov. 9, 2009, the disclosure of which is incorporated herein in its entirety by reference thereto. This invention relates to a scan test circuit for a semiconductor integrated circuit and a scan test method therefor, and more specifically to a scan test circuit to perform a delay fault test on a memory peripheral circuit of a semiconductor integrated circuit device and a scan test method therefor.

### TECHNICAL FIELD

### Background

With the increase in the size of a semiconductor large scale integrated circuit device (Large Scale Integrated (LSI) circuit), the number of combinations of test patterns for functional testing of an LSI required during the manufacturing increases and the test becomes more complicated. Therefore, it has become difficult to design test patterns. In recent years, a test using DFT (Design For Testability) technology is generally used.

Moreover, recent LSI circuits include many built-in memories in order to process large amounts of data rapidly in image processing, etc. It is not seldom that the number of built-in memories exceeds several hundred in a recent LSI circuit having a large circuit size and being miniaturized. Since the yield rate of memories is lower than those of macro and logic circuits, the yield rate of LSI circuits depends largely on the yield rate of memories. Therefore, an LSI circuit with many built-in memories generally employs a memory with a built-in repair function.

Moreover, since a large amount of data is processed rapidly in image processing, etc., a delay fault test, in which the memory cell is dealt with as a sequential circuit, is performed on the memory peripheral circuits. Since a sequential circuit algorithm is used in generating a scan pattern, the number of test patterns increases with the increase of the number of built-in memories and a large amount of the LSI test time is occupied by the test time for the memory peripheral circuits. Therefore, there is an increasing need to reduce test time required for a test on the memory macro peripheral circuits of a memory with a built-in repair function.

Patent Document 1 describes a semiconductor integrated circuit for performing, at low cost, a stuck-at fault test and a delay fault test on a memory peripheral circuit of a memory with a built-in repair function (namely, with a redundant structure for faulty cell recovery).

FIG. 14 is a diagram illustrating a structure of an LSI circuit with a memory test circuit described in Patent Document 1. As shown in FIG. 14, a semiconductor integrated circuit 100 includes a memory circuit 3 having memory cells 1 and a redundant cell 2 for avoiding a faulty cell 1a among the memory cells 1, in which a fault has occurred, to achieve repair; a fuse circuit 4 for determining a logic for repairing the memory circuit 3 based on a repair code for avoiding the faulty cell 1a detected as a result of testing the memory circuit 3 and for using the redundant cell 2, and a fuse register 5, or a first register, which is controlled by output signals of the fuse circuit 4. The semiconductor integrated circuit 100 further includes a stuck-at fault test register 6, or a second register, which is provided with a scan design for testing stuck-at faults, and has a test input and a test output; and a register selection circuit (multiplexer, MUX) 7, whose input is connected with an output of the fuse register 5 and the output of the stuck-at fault test register 6, so that, in outputting signals, when delay faults are to be tested, switching is performed to receive output signals of the fuse register 5, and when stuck-at faults are to be tested, switching is performed to receive output signals of the stuck-at fault test register 6.

The semiconductor integrated circuit 100 further includes a first flip-flop (FF) 8a and a second flip-flop 8b, which are disposed in the semiconductor integrated circuit 100; a first user circuit 9a for processing output signals of the first flip-flop 8a and outputting predetermined signals; a second user circuit 9b for processing output signals of the memory circuit 3 and outputting predetermined signals; a first switching circuit 10a which is connected between the first user circuit 9a and inputs of the memory circuit 3 to switch the inputs of the memory circuit 3 from a first signal path including a path to which the faulty cell 1a is connected, to a second signal path including a path to which the redundant cell 2 is connected for avoiding the path to which the faulty cell 1a is connected; and a second switching circuit 10b which is connected between the second user circuit 9b and outputs of the memory circuit 3 to switch the outputs of the memory circuit 3 from the first signal path to the second signal path. The semiconductor integrated circuit 100 further includes a memory bypass circuit 11, which is connected to the inputs and the outputs of the memory circuit 3 and disposed between the first switching circuit 10a and the second switching circuit 10b to test stuck-at faults; and a decoding circuit 12 for outputting signals to control the first and second switching circuits 10a and 10b based on the output of the register selection circuit 7.

It should be appreciated that the first and second switching circuits 10a and 10b here are each made up of a plurality of multiplexers. Further, the memory bypass circuit 11 includes bypass wirings 11a, whose each one end is connected between one of the inputs of the memory circuit 3 and an output of the first switching circuit 10a; and multiplexers 11b whose each input is connected with one of the outputs of the memory circuit 3 and the other end of the bypass wiring 11a, and whose each output is connected to an input of the second switching circuit 10b.

If the faulty cell 1a is present in the memory circuit 3 as shown in FIG. 14, a repair code is determined based on information outputted to an external tester through a BIRA circuit, not shown, for example, so that a fuse element in the fuse circuit 4 is fused for establishing a repair logic for every semiconductor integrated circuit 100. The repair code written in the fuse circuit 4 is read out to the fuse register for control of the first switching circuit 10a and the second switching circuit 10h by the decoding circuit 12.

Upon reception of the control signals from the decoding circuit 12, each of the first switching circuit 10a and the second switching circuit 10b is controlled so that its multiplexers are switched to avoid a path to which the faulty cell 1a is connected and to transmit predetermined signals to a path to which the redundant cell 2 is connected.

Under such circumstances, once reading-out/writing-in operation for the memory circuit 3 is carried out by the first user circuit 9a that has received a predetermined output from the first flip-flop 8a, the memory circuit 3 normally outputs predetermined data using the second signal path including the path connected to the redundant cell 2 for avoiding the path to which the faulty cell 1a is connected. The outputted data is then introduced into the second flip-flop 8b through the second user circuit 9b.

Description is now provided on tests of stuck-at faults and delay faults in the semiconductor integrated circuit 100 having the configuration as described above. It should be noted that the description here is provided for the case where the tests of stuck-at faults and delay faults are performed with the memory circuit 3 being in a state of having been reset (recovered).

The test of stuck-at faults (the test via the memory bypass circuit) is performed, for example, by inputting a predetermined test pattern into the first flip-flop 8a and the stuck-at fault test register 6, controlling the memory bypass circuit 11, detecting signals outputted to the second flip-flop 8h, and comparing the detected signals with a predetermined expectation value. Thus, the test of stuck-at faults is performed for the first and second user circuits 9a and 9b, the first and second switching circuits 10a and 10b, and the decoding circuit 12. In this connection, when testing stuck-at faults, the memory bypass circuit 11 is rendered to switch the multiplexers 11b so as to select and output the signals that have been inputted from the first user circuit 9a and transmitted to the bypass wirings 11a bypassing the memory circuit 3.

In addition, as shown in FIG. 14, the memory bypass circuit 11 is arranged at a side nearer to the memory circuit 3 than the first and second switching circuits 10a and 10b. Accordingly, stuck-at faults not only in the first and second user circuits 9a and 9b but also in the first and second switching circuits 10a and 10b (particularly, stuck-at faults in input terminals 13a to 13h and output terminals 14a to 14c of the first switching circuit 10a, and input terminals 15a to 15f and output terminals 16a to 16d of the second switching circuit 10b, which include portions that do not operate when switched as a result of rescue) can also be further tested.

As described above, being provided with a scan design, the stuck-at fault test register 6 has a scan register having the test input and the test output. Therefore, all the stuck-at faults can be tested by writing any test pattern into the stuck-at fault test register 6 that has been selected by the register selection circuit 7, from the test input and the test output, and by decoding the test pattern at the decoding circuit 12. This is because any combination can be dealt with in a controllable manner without relying on a rescue code.

Owing to the repair of the memory circuit 3, whatever rescue codes are written into the fuse circuit 4, the output of the fuse circuit 4 is not inputted to the stuck-at fault test register 6, whereby no influence is brought to a test pattern for testing stuck-at faults. Thus, a test pattern for testing stuck-at faults does not have to be prepared for every rescue code.

On the other hand, the test of delay faults (the test via the memory circuit) is performed by, for example, inputting a predetermined test pattern from the first flip-flop 8a, bringing the memory circuit 3 into a state of being rescued, having the multiplexers 11b selected a memory output-side, detecting signals outputted to the second flip-flop 8b, and comparing the detected signals with a predetermined expectation value. For this purpose, the fuse register 5 is selected by the register selection circuit 7, and the memory circuit 3 is set to be in the state of being rescued by the decoding circuit 12 based on the output of the fuse register 5. Then, reading-out/writing-in operation is performed for the memory circuit 3 with a test pattern for delay faults. The reason why such a setting is enabled is that the fuse register 5 is not provided with a scan design, and that therefore the fuse register 5 is allowed to read out a rescue code from the fuse circuit 4 as a normal operation (rescued-state operation) even in the test mode.

In this way, in the delay fault test mode, the memory bypass circuit 11 selects the output data of the memory circuit 3 in order to enable reading/writing of the memory cells 1. In FIG. 14, for the delay faults in the first and second switching circuits 10a and 10b, portions subjected to testing are those which operate in the rescued state of the memory (the input terminals 13b and 13d, the output terminals 14a and 14b, the input terminals 15a, 15c, 15e and 15h, and the output terminals 16a to 16d).

Accordingly, although the same test pattern is used, the portions to be tested in the first and second switching circuits 10a and 10b depend on the rescue code written in the fuse circuit 4.

As described above, being not provided with a scan design, the fuse register 5 fetches a rescue code from the fuse circuit 4 as a normal operation in the test mode for delay faults, thereby bringing the memory circuit 3 into a repaired state. Therefore, for example, no test pattern incorporating a rescue code is required to be set in the tester, not shown. In other words, it is possible to utilize and input from the tester a generally used test pattern not relying on a rescue code.

In this way, comparing with the conventional art described above, the semiconductor integrated circuit 100 is additionally provided with the stuck-at fault test register 6 in which a scan design is given to the bit width/number of the fuse register 5, and with the register selection circuit 7. Thus, the first and second user circuits 9a and 9b, the pattern for enabling test of stuck-at faults throughout the entire rescue circuit, and the test pattern for delay faults that performs reading/writing for the memory circuit 3, are ensured to be utilized without relying on a rescue code of the fuse circuit 4.

### [Patent Document 1]

Japanese Patent Kokai Publication No. JP-P2007-095192A (particularly, page 14, FIG. 1)

### SUMMARY

The entire disclosure of the above Patent Document is incorporated herein by reference thereto. Now, the following analyses are given by the present invention.

The semiconductor integrated circuit (LSI circuit) described in Patent Document 1 requires an extraordinary long time for a delay fault test on a memory peripheral circuit. In order to perform a delay fault test on the memory peripheral circuit based on a scan test, it is necessary to generate the following test pattern using a sequential circuit algorithm. In the test pattern, the scan FF (first flip-flop circuit 8a) disposed at the data input side of the memory circuit 3 composes a shift register structure and a value is set to the scan FF. After the shift register structure is released, the memory circuit 3 reads a value stored in the scan FF (first flip-flop circuit 8a) via the combinational circuit (first user circuit 9a) disposed at the data input side of the memory circuit 3. Furthermore, the scan FF (second flip-flop circuit 8h) reads the logic state of the memory circuit 3 via the combinational circuit (second user circuit 9b) disposed at the output side. Finally, the value is read in a shift register structure. Moreover, when the memory circuit 3 is treated as a sequential circuit, the memory address is fixed so that a single memory cell is accessed during the test. Therefore, it is necessary to set a test pattern to many scan FFs.

FIG. 15 is a diagram schematically illustrating a setting of values for scan FFs for detecting a failure of a conventional memory peripheral circuit, in which the memory core is treated as a sequential circuit. A combinational circuit 82 is connected to each of memory addresses AD[m:0]. A test, in which the memory circuit is treated as a sequential circuit (virtual FF 40), is performed. The addresses AD[m:0] have a fixed value so that the memory circuit is treated as a virtual FF 40 during the test. For this purpose, a value is set to the scan FF 42 while considering a logic state of the combinational circuit 82, and a value is set to the scan FF 43 while considering a logic state of the combinational circuit 83. Therefore, it is necessary to perform settings on many scan FFs. Furthermore, logic propagation from the scan FFs 42, 43 to the other memory address or to the data input DI[n:0] may occur. In this case, combinational circuits (first user circuit 9a or second user circuit 9b) that can be tested at a time are restricted, and the number of faults that can be detected using a single test pattern becomes smaller. Therefore, much more test patterns are required than in a circuit with only scan FFs, and a much longer test time is required.

Therefore, there is a need in the art to provide a scan test circuit and a scan test method for reducing time required for a delay fault test on a memory peripheral circuit.

According to a first aspect of the present invention, there is provided a scan test circuit for a memory comprising a plurality of first memory cell columns, a second memory cell column that replaces a failed column of the plurality of first memory cell columns, a first switching circuit that connects one of the plurality of first memory cell columns and the second memory cell column to a first peripheral circuit disposed at an input side, and a second switching circuit that connects one of the plurality of first memory cell columns and the second memory cell column to a second peripheral circuit disposed at an output side. The scan test circuit comprises: a test priority control circuit that controls the first switching circuit and the second switching circuit to establish at least two patterns of connections between the plurality of first and second memory cell columns, and the first and second peripheral circuits; and a test point circuit that includes scan flip-flop circuits employed in a scan test for detecting a delay fault of the first peripheral circuit and the second peripheral circuit, and is disposed between the plurality of first and second memory cell columns, and the first switching circuit.

According to a second aspect of the present invention, there is provided a scan test method for a memory comprising a plurality of first memory cell columns, a second memory cell column that replaces a failed column of the plurality of first memory cell columns, a first switching circuit that connects one of the plurality of first memory cell columns and the second memory cell column to a first peripheral circuit disposed at an input side, and a second switching circuit that connects one of the plurality of first memory cell columns and the second memory cell column to a second peripheral circuit disposed at an output side. The method comprises: controlling the first switching circuit and the second switching circuit to establish at least two patterns of connections between the plurality of first and second memory cell columns, and the first and second peripheral circuits; and performing a scan test for detecting a delay fault of the first peripheral circuit and the second peripheral circuit using: a scan flip-flop circuit within a test point circuit that is disposed between the plurality of first and second memory cell columns, and the first switching circuit; a scan flop-flop circuit connected to input of the first peripheral circuit; and a scan flip-flop circuit connected to output of the second peripheral circuit.

The present invention provides the following advantage, but not restricted thereto. The scan test circuit and the scan test method according to the present invention reduce time required for a delay fault test on a memory peripheral circuit.

### BRIEF DESCRIPTION OF THE DRAWINGS

FIG. 1 is a diagram illustrating an example of a structure of an LSI circuit that includes a scan test circuit according to a first exemplary embodiment.

FIG. 2 is a diagram illustrating an example of a structure of a test point circuit of the scan test circuit according to the first exemplary embodiment.

FIG. 3 is a diagram illustrating an example of a structure of a test priority control circuit of the scan test circuit according to the first exemplary embodiment.

FIG. 4 is a flowchart illustrating an operation (generation of a scan pattern for testing a memory peripheral circuit) of the scan test circuit according to the first exemplary embodiment.

FIG. 5 is a flowchart illustrating an operation (test) of the scan test circuit according to the first exemplary embodiment.

FIG. 6 is a flowchart illustrating detail of the operation (test) of the scan test circuit according to the first exemplary embodiment.

FIG. 7 is a diagram illustrating an example of a structure of an LSI circuit that includes a scan test circuit according to the first exemplary embodiment and a faulty memory cell.

FIG. 8 is a diagram illustrating an example of a structure of an LSI circuit that includes a scan test circuit according to the first exemplary embodiment and has had the faulty memory cell repaired (faulty cell repair).

FIG. 9 is a diagram illustrating an example of a structure of an LSI circuit that includes a scan test circuit according to a second exemplary embodiment.

FIG. 10 is a diagram illustrating an example of a structure of a test point circuit of the scan test circuit according to the second exemplary embodiment.

FIG. 11 is a diagram illustrating an example of a structure of an LSI circuit that includes a scan test circuit according to a third exemplary embodiment.

FIG. 12 is a diagram illustrating an example of a structure of a test point circuit of the scan test circuit according to the third exemplary embodiment.

FIG. 13 is a diagram illustrating an example of a structure of a test point circuit of the scan test circuit according to the third exemplary embodiment.

FIG. 14 is a diagram illustrating an example of structure of an LSI circuit that includes a conventional memory test circuit.

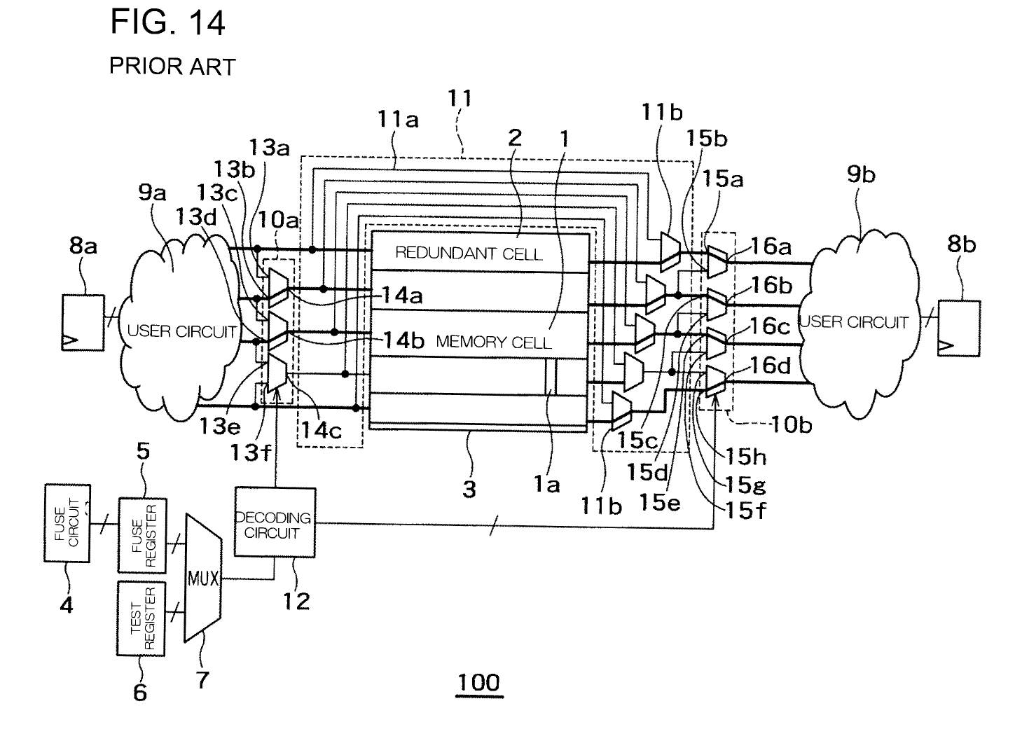

FIG. 15 is a diagram illustrating an exemplary setting of values for scan FFs for detecting a failure of a memory peripheral circuit when the memory core is treated as a sequential circuit.

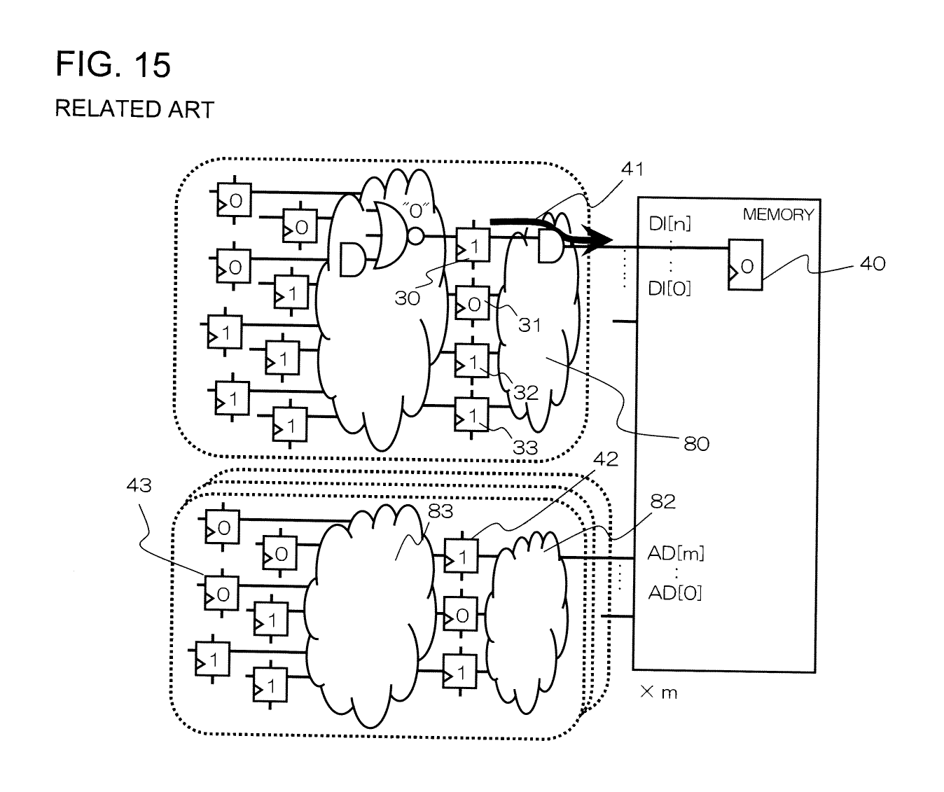

### PREFERRED MODES

In the present disclosure, there are various possible modes, which include the following, but not restricted thereto. A scan test circuit in a first mode may be a scan test circuit according to the above first aspect.

In a scan test circuit according to a second mode, the test point circuit may be adapted to receive a control signal for the memory.

In a scan test circuit according to a third mode, the control signal may be an enable signal for the memory.

In a scan test circuit according to a fourth mode, the control signal may be an address signal for the memory.

A semiconductor integrated circuit device according to a fifth mode may preferably comprise the above scan test circuit.

A scan test method in a sixth mode may be a scan test method according to the second aspect.

In a scan test method according to a seventh mode, the scan test may be performed using a test pattern generated based on a combinational circuit algorithm.

In a scan test method according to an eighth mode, the scan test may be performed without fixing an address of the memory.

According to a scan test circuit and a scan test method of preferred modes of the present invention, since scan FFs disposed in a test point circuit are used instead of a memory circuit in a delay fault test on a memory peripheral circuit, there is no need to use a sequential circuit algorithm and to fix a memory address of the memory circuit. Therefore, it is possible to generate a test pattern, by which many faults can be detected, and reduce time required for a delay fault test.

### First Exemplary Embodiment

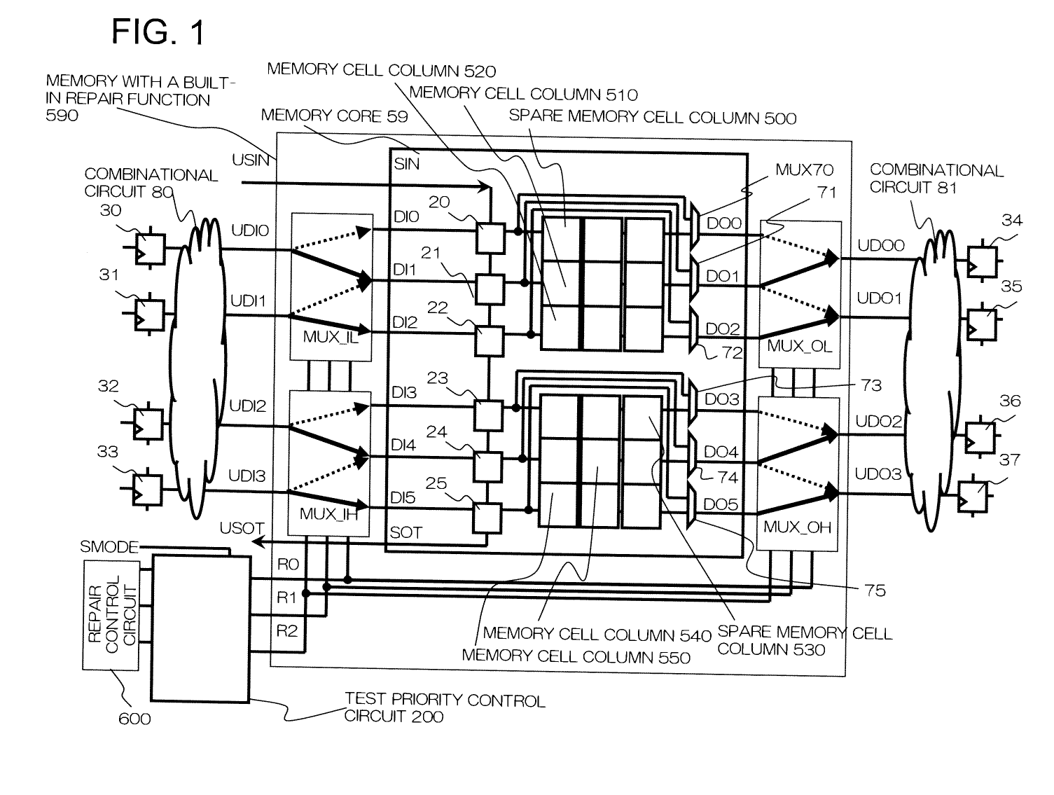

A scan test circuit according to a first exemplary embodiment is described with reference to the drawings. FIG. 1 is a diagram illustrating a structure of an LSI circuit that includes the scan test circuit according to the first exemplary embodiment. With reference to FIG. 1, the LSI circuit includes combinational circuits 80 and 81, scan FFs 30-37, a memory with a built-in repair function 590, a test priority control circuit 200, and a repair control circuit 600.

Data outputs of the scan FFs 30-33 are connected, respectively, to first to fourth input terminals of the first combinational circuit 80. First to fourth outputs of the first combinational circuit 80 are connected, respectively, to input terminals UDI0-UD13 of the memory with a built-in repair function 590. Output terminals UDO0-UDO3 of the memory with a built-in repair function 590 are connected, respectively, to first to fourth inputs of the second combinational circuit 81. First to fourth outputs of the second combinational circuit 81 are connected, respectively, to data inputs of the scan FF 34-37. First to third outputs of the repair control circuit 600 are connected, respectively, to first to third inputs of the test priority control circuit 200. A control signal SMODE is connected to a fourth input of the test priority control circuit 200. First to third outputs of the test priority control circuit 200 are connected, respectively, to input terminals R0-R2 of the memory with a built-in repair function 590.

The memory with a built-in repair function 590 comprises an input lower order bits switching circuit MUX_IL, an input higher order bits switching circuit MUX_IH, an output lower order bits switching circuit MUX_OL, an output higher order bits switching circuit MUX_OH, and a memory core 59. The memory core 59 comprises test point circuits 20-25, a spare memory cell columns 500, 530, memory cell columns 510, 520, 540, 550, and MUXs 70-75.

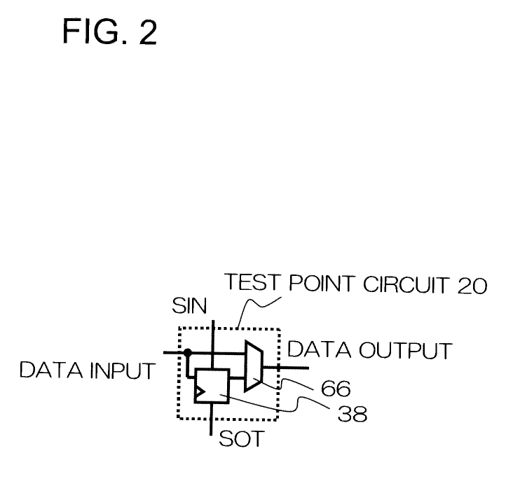

FIG. 2 illustrates the test point circuit 20 in detail. The test point circuits 21-25 have the same structures as the test point circuit 20. With reference to FIG. 2, the test point circuits 20-25 comprise a scan FF 38, and an MUX 66.

With reference to FIG. 2, input SIN of the test point circuits 20-25 is connected to input SIN of the scan FF 38. Data input of the test point circuits 20-25 is connected to data input of the scan FF 38 and first input of the MUX 66. Data output of the scan FF 38 is connected to a second input of the MUX 66. Output SOT of the scan FF 38 is connected to output SOT of the test point circuits 20-25. Output of MUX66 is connected to data output of the test point circuits 20-25.

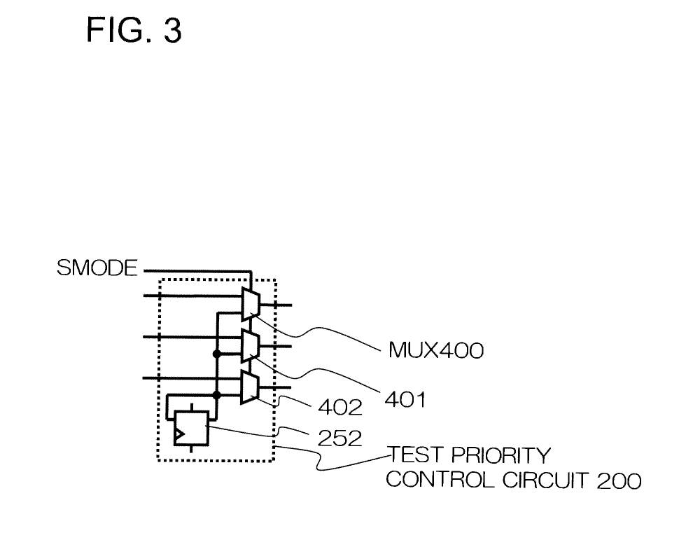

FIG. 3 illustrates the test priority control circuit 200 in detail. With reference to FIG. 3, the test priority control circuit 200 includes a scan FF 252 and MUXs 400-402. With reference to FIG. 3, first to third input of the test priority control circuit 200 are connected, respectively, to first inputs of the MUXs 400-402. Data output of the scan FF 252 is connected to data input of the scan FF 252 and second inputs of the MUXs 400-402. Fourth input of the test priority control circuit 200 is connected to select input of the MUXs 400-402. Output of the MUXs 400-402 is connected to first to third outputs of the test priority control circuit 200.

With reference to FIG. 1, inputs UDI0, UDI1 of the memory with a built-in repair function 590 are connected, respectively, to first input and second input of the input lower order bits switching circuit MUX_IL. Inputs UDI2, UDI3 of the memory with a built-in repair function 590 are connected, respectively, to first input and second input of the input higher order bits switching circuit MUX_IH. Input USIN of the memory with a built-in repair function 590 is connected to input SIN of the memory core 59.

Input terminals R0-R2 of the memory with a built-in repair function 590 are connected, respectively, to first to third select inputs of the input lower order bits switching circuit MUX_IL, input higher order bits switching circuit MUX_IH, output lower order bits switching circuit MUX_OL, and output higher order bits switching circuit MUX_OH. First to third outputs of the input lower order bits switching circuit MUX_IL are connected, respectively, to DI0-DI2 of the memory core 59. First to third outputs of the input higher order bits switching circuit MUX_IH are connected, respectively, to DI3-DI5 of the memory core 59.

Outputs DO0-DO2 of the memory core 59 are connected, respectively, to first to third data inputs of the output lower order bits switching circuit MUX_OL. Outputs DO3-DO5 of the memory core 59 are connected, respectively, to first to third data inputs of the output higher order bits switching circuit MUX_OH. Output SOT of the memory core 59 is connected to output USOT of the memory with a built-in repair function 590.

First and second outputs of the output lower order bits switching circuit MUX_OL are connected, respectively, to outputs UDO0, UDO1 of the memory with a built-in repair function 590. First and second outputs of the output higher order bits switching circuit MUX_OH are connected. Respectively, to outputs UDO2, UDO3 of the memory with a built-in repair function 590.

Inputs DI0-DI5 of the memory core 59 are connected respectively to data inputs of the test point circuits 20-25. Input SIN of the memory core 59 is connected to input SIN of the test point circuit 20.

Data output of the test point circuit 20 is connected to input of the spare memory cell column 500 and first input of the MUX 70. Data output of the test point circuit 21 or 22 is connected to input of the memory cell column 510 or 520 and first input of the MUX 71 or 72. Data output of the test point circuit 23 is connected to input of the spare memory cell column 530 and first input of the MUX 73. Data output of the test point circuit 24 or 25 is connected to input of the memory cell column 540 or 550 and first input of the MUX 74 or 75.

Outputs SOT of the test point circuits 20-24 are connected, respectively, to inputs SIN of the test point circuits 21-25. Output SOT of the test point circuit 25 is connected to output SOT of the memory core 59.

Output of the spare memory cell column 500 is connected to second input of the MUX 70. Output of the memory cell column 510 or 520 is connected to second input of the MUX 71 or 72. Output of the spare memory cell column 530 is connected to second input of the MUX 73. Output of the memory cell column 540 or 550 is connected to second input of the MUX 74. Outputs of MUXs 70-75 are connected, respectively, to output terminals DO0-DO5 of the memory core 59.

Although the scan FF 252 of the test priority control circuit 200, input SIN and input SOT of the scan FFs 30-37 are connected serially (to compose a scan chain), the connection is omitted in FIG. 1. In a similar manner, connections of the scan FF 252 and scan FFs 30-38 to clock input and scan mode input to switch between input SIN and data input, and connection of the memory core 59 to address input and clock input are omitted in the drawing.

An ordinary operation/scan operation switch input, not shown, is connected to the control input of the MUX 66 in the test point circuits 20-25. The ordinary operation/scan operation switch input selects the first input of the MUX 66 and outputs the data input to the data output in an ordinary operation, whereas in a scan path operation, selects the second input of the MUX 66 and outputs data from the scan FF38 to the data output.

With reference to FIGS. 1-3, an operation of the test priority control circuit and the test point circuits 20-25 is now explained.

If the ordinary operation/scan operation switch input, not shown, connected to the control input of the MUX 66 in the test point circuits 20-25 is set to a scan operation mode (“1” for example), the MUX 66 disposed within the test point circuits 20-25 outputs data from the scan FF 38 to the data output and the MUXs 70-75 output, respectively, outputs from the test point circuits 20-25 to the output terminals DO0-DO5.

The test priority control circuit 200 controls the MUXs 400-402 using the control signal SMODE so as to output outputs from the repair control circuit 600 to the input terminals R0-R2 of the memory with a built-in repair function 590 in an ordinary operation (“SMODE=0”), and in a test operation of the memory peripheral circuits (“SMODE=1”) to output an output from the scan FF 252 in the test priority control circuit 200 to the input terminals R0-R2 of the memory with a built-in repair function 590.

When the ordinary operation/scan operation switch input, not shown, of the LSI circuit is set to the scan operation mode (“1” for example) and a scan shift operation is set through a scan mode input, not shown, an arbitrary value can be stored in the scan FF 252. Furthermore, when the control signal SMODE is set to a value (“1”) that corresponds to the test operation of the memory peripheral circuits in the scan operation mode, an output from the scan FF 252 is output to the input terminals R0-R2 of the memory with a built-in repair function 590 so that the input lower order bits switching circuit MUX_IL, input lower order bits switching circuit MUX_IH, output lower order bits switching circuit MUX_OL, and output higher order bits switching circuit MUX_OH can be set to either of a state of the highest rank (“1” is stored in the scan FF 25) or a state of the lowest rank (“0” is store in the scan FF 25) out of the all possible combinations in repaired states.

The test method according to the present exemplary embodiment is described in the following.

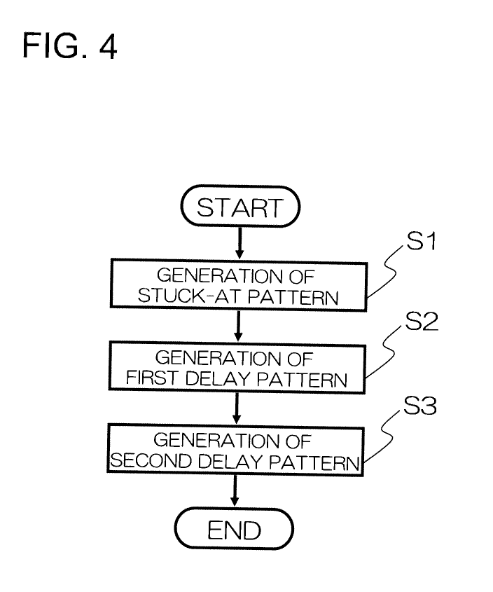

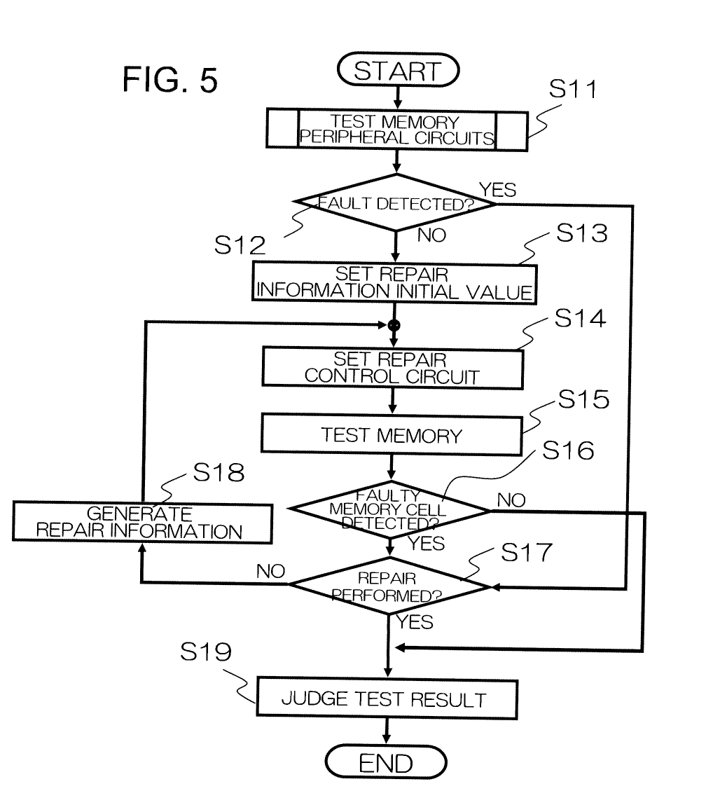

First, a step of generating a scan pattern is described. A scan pattern for testing the memory peripheral circuits is generated beforehand following a known procedure shown in FIG. 4. Following the procedure shown in FIG. 5, a test is performed using the scan pattern on the memory with a built-in repair function according to the present exemplary embodiment and the memory peripheral circuits.

### 1) Generation of Stuck-at Pattern (Step S1)

Generate a scan pattern (stuck-at pattern) for performing a stuck-at fault test on a memory peripheral circuit. Set the LSI to a scan path operation mode and connect a bypath line that logically separates the memory cell column and the spare memory cell column. Set the ordinary operation/scan operation switch input, not shown, to a scan operation mode. Set the control signal SMODE to “1” so that the MUXs 400-402 in the test priority control circuit 200 shown in FIG. 3 select an output from the scan FF 252. Moreover, the MUXs 70-75, whose control signal and control signal generation circuit are not shown, select a path that bypasses the memory cell columns 510, 520, 540, and 550, and the spare memory cell columns 500 and 530 so that the memory cell columns are separated logically. The MUXs 70-75 output an output from the test point circuits 20-25 to output terminals DO0-DO5 of the memory core 59. Under this condition, a scan pattern for detecting a stuck-at fault is generated for the combinational circuits 80, 81 by using the input lower order bits switching circuit MUX_IL, input lower order bits switching circuit MUX_IH, output lower order bits switching circuit MUX_OL, output higher order bits switching circuit MUX_OH, test point circuits 20-25 and scan FFs 30-37.

### 2) Generation of First Delay Pattern (Step S2)

Generate a scan pattern for performing a delay fault test on the memory peripheral circuits in a state of the highest rank out of the all possible combinations in repaired states. In a similar manner as in step S1, set the LSI to a scan path operation mode and connect a bypass wiring that logically separates the memory cell column and spare memory cell column. In order to perform a test in a state of the highest rank (“1” is stored in the scan FF 252) out of the all possible combinations in repaired states, a scan pattern design support tool must store “1” in the scan FF 252. Under this condition, a scan pattern for detecting a delay fault is generated for the combinational circuits 80, 81, the input lower order bits switching circuit MUX_IL, input lower order bits switching circuit MUX_IH, output lower order bits switching circuit MUX_OL, output higher order bits switching circuit MUX_OH by using the test point circuits 20-25 and scan FFs 30-37.

### 3) Generation of Second Delay Pattern (Step S3)

Generate a scan pattern for performing a delay fault test on the memory peripheral circuits in a state of the lowest rank out of the all possible combination in repaired states. In a similar manner as in step S1, set the LSI to a scan path operation mode and connect a bypass wiring that logically separates the memory cell column and the spare memory cell column. In order to perform a test in a state of the highest rank (“0” is stored in the scan FF 252) out of the all possible combinations in repaired states, a scan pattern design support tool must store “0” in the scan FF 252. Under this condition, a scan pattern for detecting a delay fault is generated for the combinational circuits 80, 81, the input lower order bits switching circuit MUX_IL, input lower order bits switching circuit MUX_IH, output lower order bits switching circuit MUX_OL, output higher order bits switching circuit MUX_OH by using the test point circuits 20-25 and scan FFs 30-37.

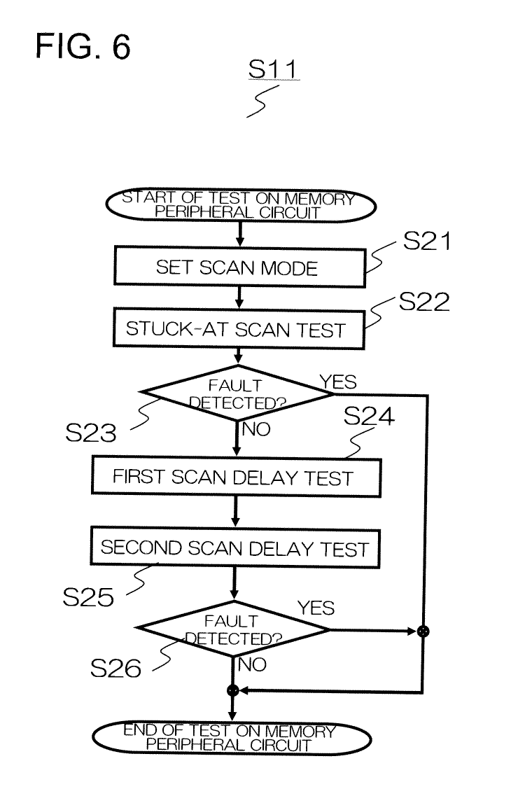

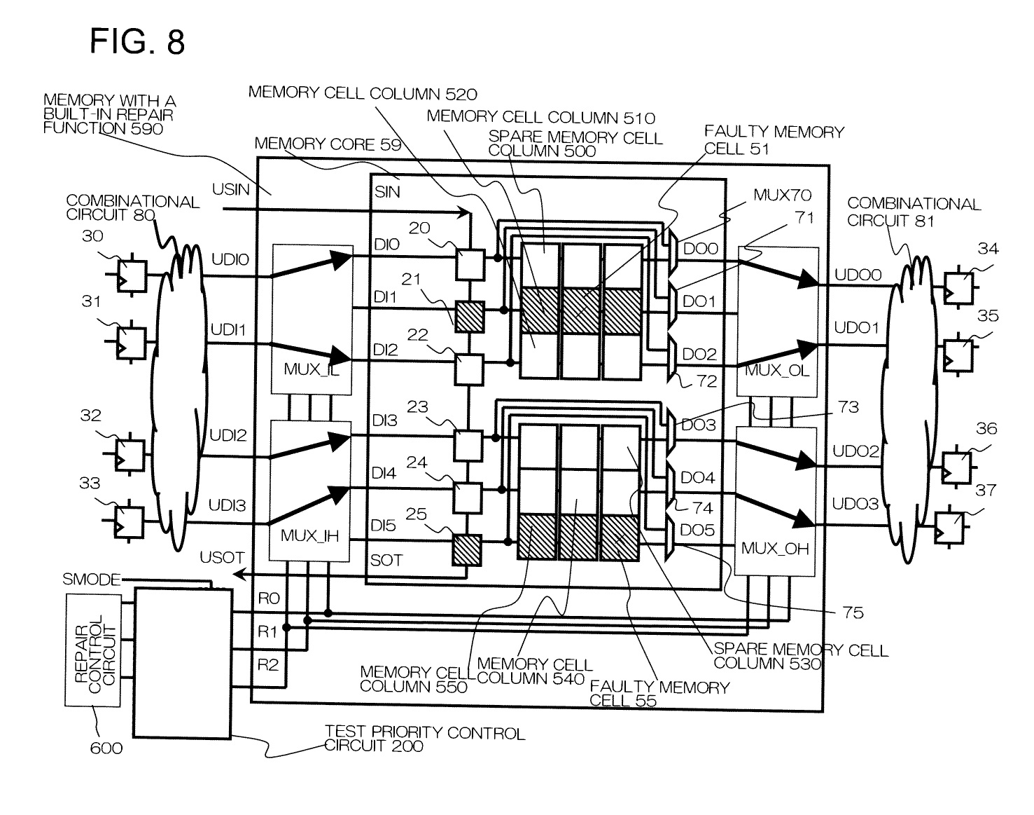

With reference to FIGS. 6 and 8, the sequence of the test method of the memory circuit and memory peripheral circuit shown in FIG. 5 is described. FIG. 5 is a flowchart illustrating a test method for the memory circuit and its peripheral circuits by the scan test circuit according to the first exemplary embodiment shown in FIG. 1. FIG. 6 is a flowchart illustrating detail of step S11 in FIG. 5 for testing memory peripheral circuits. FIG. 8 is a diagram illustrating a structure of the LSI circuit with a scan test circuit that has had the faulty cells 51 and 55 repaired (faulty cell repair) using the spare memory cell columns 500 and 530.

### 1) Test Memory Peripheral Circuits (Step S11)

Perform a test on the memory peripheral circuits. The detail of step S11 is described in the following with reference to FIG. 6. With reference to FIG. 6, detail of step S11 is described in the following.

### 1-1) Set Scan Mode (Step S21)

Set the LSI to a scan pass operation mode and connect a bypass wiring that logically separates the memory cell column and the spare memory cell column in order to perform a test on the memory peripheral circuits. Set the ordinary operation/scan operation mode switch input, not shown, to a scan operation mode. Set the control signal SMODE to “1” so that the MUXs 401-402 in the test priority control circuit 200 shown in FIG. 3 select an output from the scan FF 252. Moreover, the MUXs 70-75 (whose control signal and control signal generation circuit are not shown) select a path that bypasses the memory cell columns 510, 520, 540, and 550, and the spare memory cell columns 500 and 530 so that the memory cell columns are separated logically. The MUXs 70-75 output an output from the test point circuits 20-25 to output terminals DO0-DO5 of the memory core 59.

### 1-2) Stuck-at Scan Test (Step S22)

A stuck-at fault test is performed on the combinational circuits 80, 81 is performed by the input lower order bits switching circuit MUX_IL, input lower order bits switching circuit MUX_IH, output lower order hits switching circuit MUX_OL, output higher order bits switching circuit MUX_OH, test point circuits 20-25 and scan FFs 30-37, using the scan pattern generated beforehand in step S1. The test priority control circuit 200 performs a test by switching arbitrarily the structure of the input lower order bits switching circuit MUX_IL, input lower order bits switching circuit MUX_IH, output lower order bits switching circuit MUX_OL and output higher order hits switching circuit MUX_OH between a structure of the highest rank (“1” is stored in the scan FF 252) and a structure of the lowest rank (“0” is stored in the scan FF 252) based on a value set to the built-in scan FF 252 by a scan pattern that is generated automatically beforehand.

### 1-3) Judge Fault (Step S23)

Judge whether a fault is detected or not from the result of the stuck-at scan test. If a fault is detected, stop the test on the memory peripheral circuits and go to step S12 of FIG. 5 to inform that a fault is detected in the stuck-at scan test. If a fault is not detected, go to step S24.

### 1-4) First Delay Scan Test (Step S24)

Perform a delay fault test on the memory peripheral circuits in a state of the highest rank out of the possible repaired states. A delay fault test on the combinational circuits 80, 81, the input lower order bits switching circuit MUX_IL, input lower order bits switching circuit MUX_IH, output lower order bits switching circuit MUX_OL, and output higher order bits switching circuit MUX_OH is performed in a state of the highest rank out of the all possible combinations in repaired states by the test point circuits 20-25 and scan FFs 30-37, based on a scan pattern generated beforehand in step S2 by fixing the value stored in the scan FF252 to “1.”

### 1-5) Second Delay Scan Test (Step S25)

Perform a delay fault test on the memory peripheral circuits in a state of the lowest rank out of the possible repaired states. A delay scan test on the combinational circuits 80, 81, the input lower order bits switching circuit MUX_IL, input lower order bits switching circuit MUX_IH, output lower order hits switching circuit MUX_OL, and output higher order bits switching circuit MUX_OH is performed in a state of the highest rank out of the all possible combination in repaired states by the test point circuits 20-25 and scan FFs 30-37, based on a test pattern generated beforehand in step S3 by fixing the value stored in the scan FF252 to “0.”

### 1-6) Judge Fault (Step S26)

Judge whether a fault is detected or not from the result of steps S22 and S23. After judging whether a fault is detected or not, stop the test on the memory peripheral circuits, go to step S12 of FIG. 5, and inform whether a fault is detected or not in the delay scan test.

### 2) Judge Fault (Step S12)

Judge whether a fault is detected or not from the result of the test on the memory peripheral circuits and determine whether or not a test on the memory is performed. If a fault is detected in at least one of the stuck-at scan test (step S22) and step S24, go to step S19. If a fault is not detected in both step S22 and step S24, go to step S13.

### 3) Set Repair Information Initial Value (Step S13)

Give an initial value (repair information initial value) that is set to the repair control circuit 600 shown in FIG. 1. In general, the repair control circuit 600 comprises: an element, not shown, such as a blown fuse that stores a repair information; and a fuse register, not shown, that reads the value. Since all fuses are not blown at this stage, it is necessary to determine which of the memory cell columns 510, 520, 540, 550 and the spare memory cell columns 500, 530 should be used. The LSI circuit is set to an initial value setting mode of the repair control circuit 600. A value for selecting the memory cell columns 510, 520, 540, 550 is input from an LSI tester, not shown, to the fuse register, not shown, of the repair control circuit 600.

### 4) Set Repair Control Circuit (Step S14)

Switch the input lower order hits switching circuit MUX_IL, output lower order hits switching circuit MUX_OL, input higher order bits switching circuit MUX_IH, output higher order hits switching circuit MUX_OH by the repair information initial value input in step S13 (or a repair information value input in the repair information generation step S18) and determine memory cell columns that make up the memory circuit. In a case where the repair information initial value is set, the spare memory columns 500, 530 are separated logically. In this case, paths between the input terminals UDI0-UDI3 and the output terminals UDO0-UDO3 in the memory with a built-in repair function 590 are given, respectively, by

UDI0→D11→memory cell column 510→DO1→UDO0,
UDI1→DI2→memory cell column 520→DO2→UDO1,
UDI2→DI4→memory cell column 540→DO4→UDO2,
UDI3→D15→memory cell column 550→DO5→UDO3.

### 5) Test Memory (Step S15)

Test the memory circuit, i.e., the memory cell of the memory with a built-in repair function 590. The test on the memory cell is performed, for example, with a BIST circuit, not shown.

### 6) Judge Fault (Step S16)

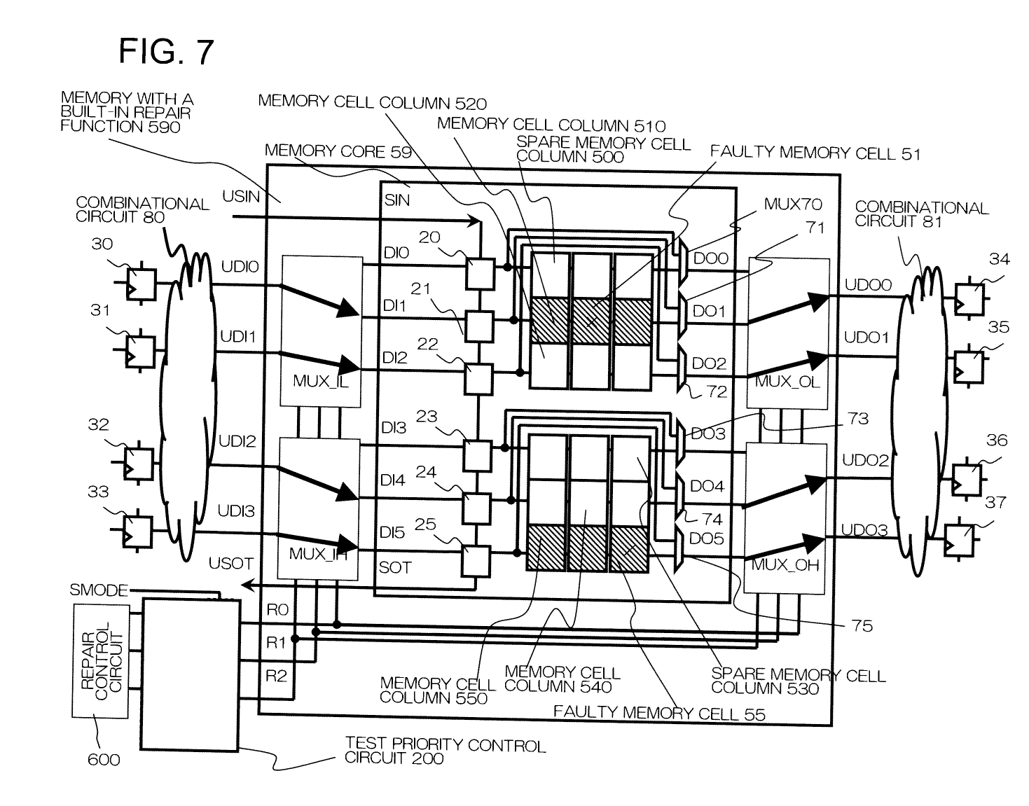

Judge the result of the memory test. If a faulty memory cell is not detected (No in step S16), go to step S19. If a faulty memory cell is detected (Yes in step S16), go to step S17. FIG. 7 illustrates an example of a case where a faulty memory cell is detected. FIG. 7 is a diagram illustrating a structure that includes the faulty memory cell according to the first exemplary embodiment and a state in which faulty memory cells 51 and 55 are detected as a result of the memory circuit test. In the present exemplary embodiment, it is to be assumed that faulty memory cells 51, 55 are detected as shown in FIG. 7.

### 7) Perform a Repair (Step S17)

Judge whether to perform a repair (step S17). Check whether a repair has been performed or not. If a repair has been performed (Yes in step S17), go to step S19. If a repair has not been performed (No in step S17), go to step S18.

### 8) Generate a Repair Information (Step S18)

Separate logically a memory cell column with a faulty memory cell and give a repair information value to the repair control circuit 600 in order to reconstruct the memory circuit using the spare memory cell columns. After performing a test on the memory circuit, i.e., the memory cell of the memory with a built-in repair function 590 by a BIST circuit, not shown, read the value stored in a faulty cell column information register of the BIST circuit, not shown, that stores a faulty cell column information through an LSI tester, not shown. Separate logically the memory cell column with a faulty memory cell. Generate a repair information value that selects the memory cell columns 520, 540 and the spare memory cell columns 50, 530 by the LSI tester, not shown, in order to reconstruct the memory circuit using the spare memory cell columns. Set the LSI circuit to an initial value setting mode of the repair control circuit 600. The repair information value is input from the LSI tester, not shown, to the fuse register, not shown, of the repair control circuit 600.

### 9) Judge Test Result (Step S19)

Judge the result of the test on the memory circuit and the memory peripheral circuits. If a faulty memory cell is not detected in step S16, the memory is determined to be non-defective. If the memory has been repaired in step S17, the memory is determined to be defective.

Two combinations of the highest rank and the lowest rank out of the all possible combinations in repaired states are selected in the present exemplary embodiment. As a combination selected from the all possible combinations in repaired states, the following combination can be selected instead of the two combinations of the highest rank and the lowest rank.

Namely, a combination can be selected, which allows: a test under a state in which the first input of the input lower order bits switching circuit MUX_IL is connected to the first output and the first input of the output lower order bits switching circuit MUX_OL is connected to the first output, and a test under a state in which the first input of the input lower order bits switching circuit MUX_IL is connected to the second output and the second input of the output lower order hits switching circuit MUX_OL is connected to the first output, respectively, at least one time;

a test under a state in which the second input of the input lower order bits switching circuit MUX_IL is connected to the second output and the second input of the output lower order bits switching circuit MUX_OL is connected to the second output, and a test under a state in which the second input of the input lower order bits switching circuit MUX_IL is connected to the third output and the third input of the output lower order bits switching circuit MUX_OL is connected to the second output, respectively, at least one time;
a test under a state in which the first input of the input higher order bits switching circuit MUX_IH is connected to the first output and the first input of the output higher order bits switching circuit MUX_OH is connected to the second output, and a test under a state in which the first input of the input higher order bits switching circuit MUX_IH is connected to the second output and the second input of the output higher order bits switching circuit MUX_OH is connected to the first output, respectively, at least one time; and
a test under a state in which the second input of the input higher order bits switching circuit MUX_IH is connected to the second output and the second input of the output higher order bits switching circuit MUX_OH is connected to the second output, and a test under a state in which the second input of the input higher order bits switching circuit MUX_IH is connected to the third output and the third input of the output higher order bits switching circuit MUX_OH is connected to the second output, respectively, at least one time.

In other words, another combination can be selected, which allows a test, at least one time, for each of the above possible connections among the input lower order bits switching circuit MUX_IL, input higher order bits switching circuit MUX_IH, output lower order bits switching circuit MUX_OL, and output higher order bits switching circuit MUX_OH.

Since the delay fault test on the memory peripheral circuit according to the present exemplary embodiment uses a scan FF disposed in the test point circuit without using the memory circuit, there is no need to use a sequential circuit algorithm and to fix a memory address of the memory circuit, and it is possible to generate a test pattern by which many faults can be detected. Therefore, according to the present exemplary embodiment, time required for a delay fault test on a memory peripheral circuit can be reduced.

### Second Exemplary Embodiment

A scan test circuit according to a second exemplary embodiment is described with reference to the drawings.

The scan test circuit according to the first exemplary embodiment is a scan test circuit for testing a memory peripheral circuit, which is connected to data input and data output of a memory circuit. A memory peripheral circuit that is connected to a control signal such as an enable signal or address signal may also be a target of a scan test.

A scan test circuit according to the present exemplary embodiment is a scan test circuit that performs a scan test on a memory peripheral circuit, which is connected to input of a control signal other than data input and data output of a memory circuit.

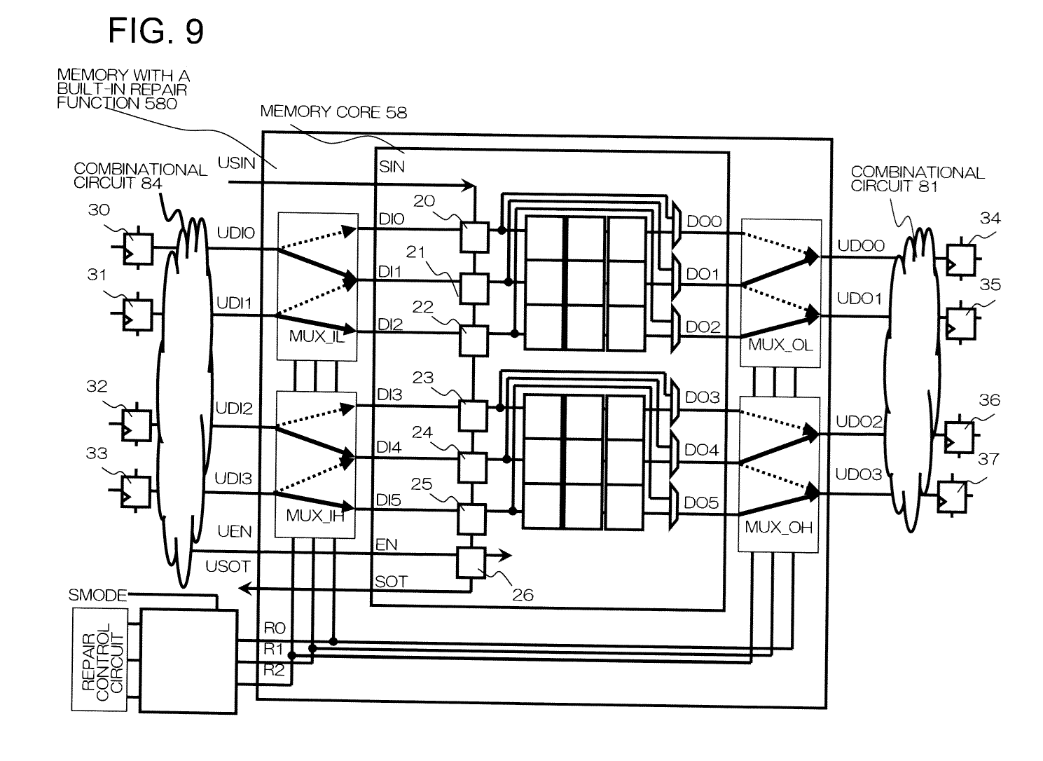

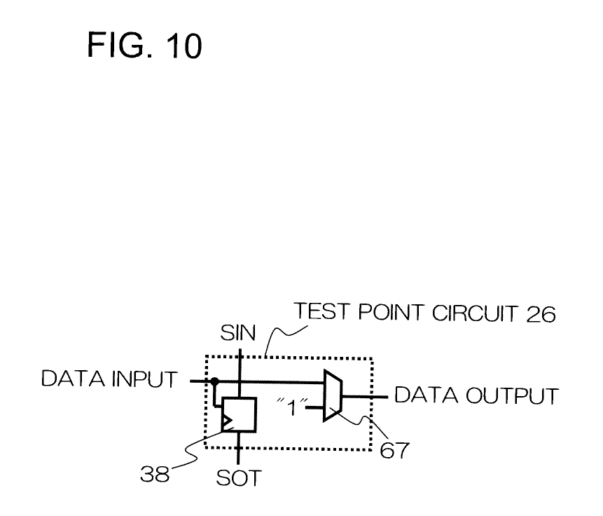

FIG. 9 is a diagram illustrating the entire structure of an LSI circuit that includes the scan test circuit according to the present exemplary embodiment. With reference to FIG. 9, illustrated is the entire of the LSI circuit that includes the scan test circuit with an enable input signal (enabling read and write operation of the memory/maintaining a logic value, or controlling to stop at a predetermined output value). FIG. 10 is a diagram illustrating an example of a structure of a test point circuit according to the present exemplary embodiment.

With reference to FIG. 9, a memory with a built-in repair function 580, further receiving an enable input signal EN connected to a fifth output of the combinational circuit 84, corresponds to the memory with a built-in repair function 590 in FIG. 1. A memory core 58, further receiving an enable input signal EN, corresponds to the memory core 59 in FIG. 1. The enable input EN is connected to data input of the test point circuit 26. Data output of the test point circuit 26 is connected to each logic within the memory core 59. Output SOT of the test point circuit 25 is connected to input SIN of the test point circuit 26. Output SOT of the test point circuit 26 is connected to output SOT of the memory core 58. Besides these differences, the scan test circuit according to the present exemplary embodiment has the same structure as the scan test circuit according to the first exemplary embodiment.

An MUX 67 in FIG. 10 corresponds to the MUX 66 in FIG. 2 and receives from the second input terminal a fixed logical value (“1”) that corresponds to a case in which the memory circuits can read and write normally. Besides this difference, the scan test point circuit 26 according to the present exemplary embodiment has the same structure as the scan test circuit 20 according to the first exemplary embodiment.

If the ordinary operation/scan operation switch input, not shown, connected to the control input of the MUX 67 in the test point circuits 26 is set to a scan operation mode (“1” for example), the MUX67 outputs to the data output a fixed logical value (“1”) that is received from the second input terminal and corresponds to a case in which the memory circuits can read and write normally.

A scan mode input, not shown, sets the LSI to a scan capture operation. A scan FF 38 within the test point circuit 26 receives as an enable input signal EN an output value from the memory peripheral circuit.

The test point circuit 26 is connected to the enable input signal EN in the present exemplary embodiment. At least in the scan path capture operation during the test, the memory circuits receives an enable logical value that corresponds to a case in which the memory circuits can read and write normally. The scan FF 38 within the test point circuit 26 receives as an enable input signal EN an output value from the memory peripheral circuit (combinational circuit 84). Therefore, it is possible to perform a delay fault test on a memory peripheral circuit connected to an enable signal EN (combinational circuit 84).

### Third Exemplary Embodiment

A scan test circuit according to a third exemplary embodiment is described with reference to the drawings.

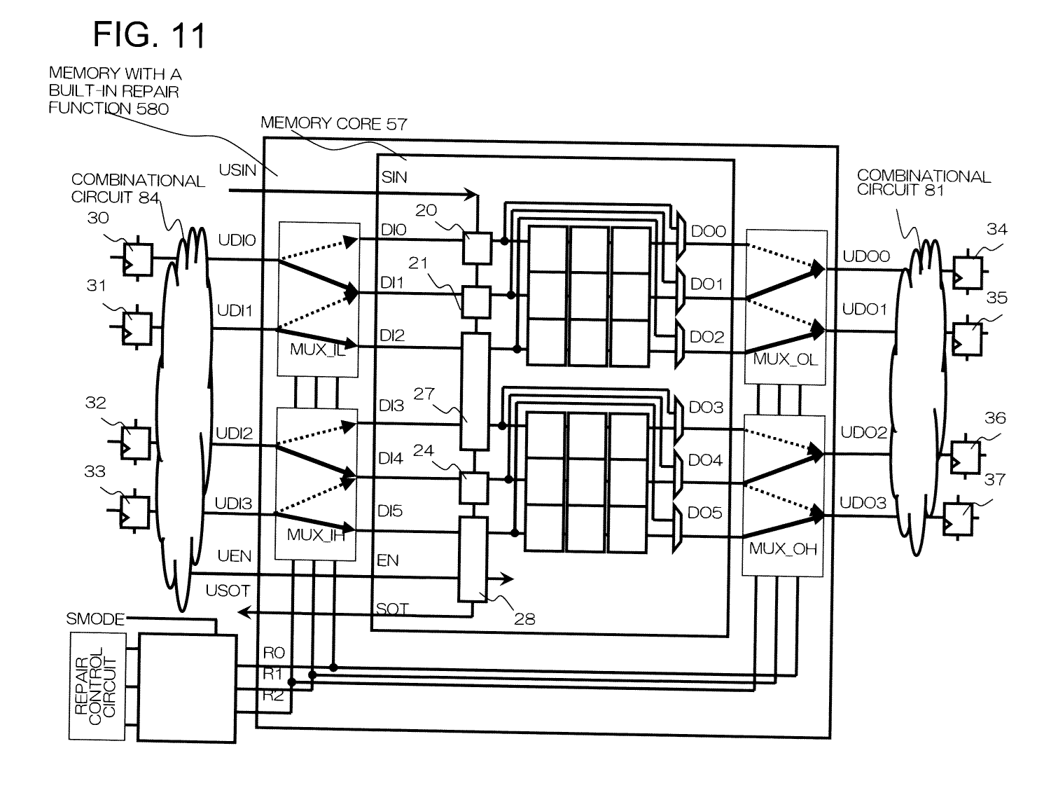

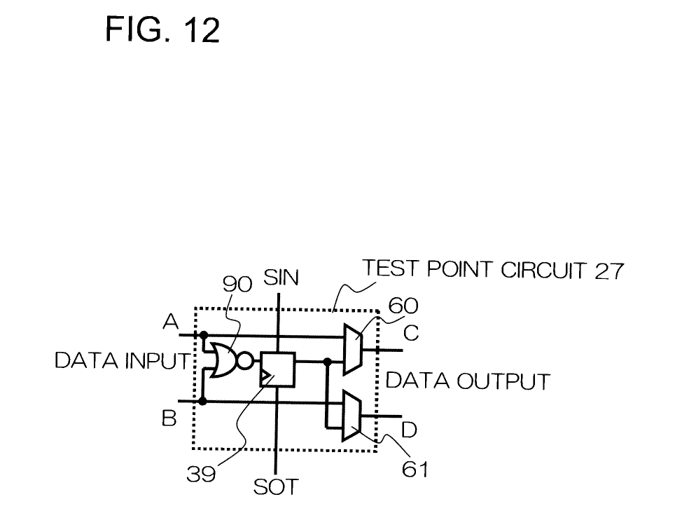

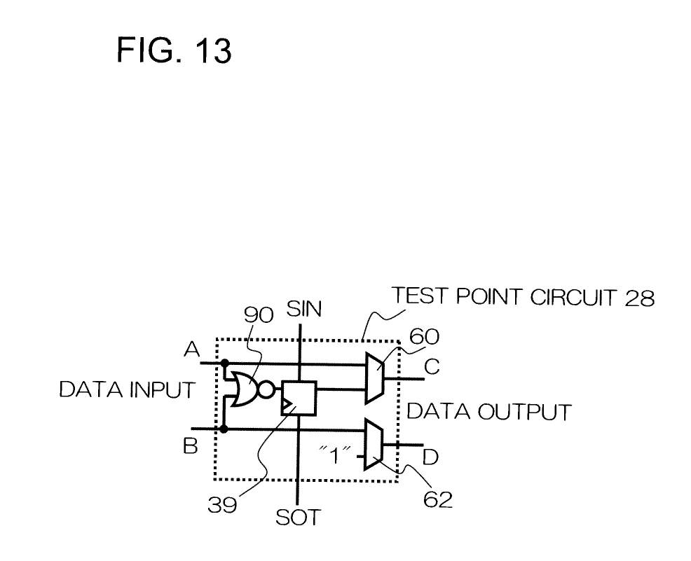

FIG. 11 is a diagram illustrating an example of the entire structure of an LSI circuit that includes a scan test circuit according to the present exemplary embodiment. FIG. 12 is a diagram illustrating an example of a structure of a test point circuit 27 according to the third exemplary embodiment. FIG. 13 is a diagram illustrating an example of a structure of a test point circuit 28 according to the third exemplary embodiment.

With reference to FIG. 11, a memory core 57 corresponds to the memory core 58 in FIG. 9. A test point circuit 27 corresponds to the test point circuit 22 and test point circuit 23 in FIG. 9. A test point circuit 28 corresponds to the test point circuit 25 and test point circuit in FIG. 9. Besides these differences, the scan test circuit according to the present exemplary embodiment has the same structure as the scan test circuit according to the second exemplary embodiment.

With reference to FIG. 12, first data input A of the test point circuit 27 is connected to first input of an NOR 90 and first input of an MUX 60. Second data input 13 of the test point circuit 27 is connected to second input of the NOR 90 and first input of an MUX 61. Input SIN of the test point circuit 27 is connected to input SIN of a scan FF 39. Output of the NOR 90 is connected to data input of the scan FF 39. Output SOT of the scan FF 39 is connected to output SOT of the test point circuit 27. Data output of the scan FF39 is connected to second inputs of the MUXs 60, 61. Outputs of the MUXs 60, 61 are connected, respectively, to first data output C and second data output D of the test point circuit 27.

With reference to FIG. 13, first data input A of the test point circuit 28 is connected to first input of an NOR 90 and first input of an MUX 60. Second data input B of the test point circuit 28 is connected to second input of the NOR 90 and first input of an MUX 62. Input SIN of the test point circuit 28 is connected to input SIN of a scan FF 39. Output of the NOR 90 is connected to data input of the scan FF 39. Output SOT of the scan FF 39 is connected to output SOT of the test point circuit 28. Data output of the scan FF39 is connected to second input of the MUX 60. The MUX 67 receives as the second input a fixed logical value (“1”) that corresponds to a case in which the memory circuits can read and write normally. Outputs of the MUXs 60, 62 are connected, respectively, to first data output C and second data output D of the test point circuit 28.

Connection of the scan FF 39 to clock input and scan mode input to switch between input SIN and data input are omitted in the drawing. An ordinary operation/scan operation switch input, not shown, to select the first input of the MUXs 60-62 and output the data input to the data output in an ordinary operation and to select the second input of the MUXs 60-62 and output to the data output in a scan path operation a fixed logical value (“1”) that corresponds to a case in which the memory circuits can read and write normally, is connected to the control input of the MUXs 60-62 in the test point circuits 27, 28.

If the ordinary operation/scan operation switch input, not shown, connected to the control input of the MUXs 60, 61 in the test point circuits 27 shown in FIG. 12 is set to a scan operation mode (“1” for example), the MUXs 60, 61 within the test point circuits 27 output data from the scan FF 39 to the first and second data outputs. If the scan FF 39 is set to a scan shift operation by a scan mode input, not shown, it is possible to set an arbitrary value to the scan FF 39 thorough a shift operation. If the scan FF 39 is set to a capture operation, the scan FF 39 receives, as an output from the NOR 90, a logic operation result of input values from the first and second data inputs by the NOR 90.

If the ordinary operation/scan operation switch input, not shown, connected to the control input of the MUXs 60, 62 in the test point circuits 28 shown in FIG. 13 is set to a scan operation mode (“1”), the MUX 60 within the test point circuits 28 outputs data from the scan FF 39 to the first data output and the MUX 62 within the test point circuits 28 outputs to the second data output a fixed logical value (“1”) that is received from the second input and corresponds to a case in which the memory circuit can read and write normally. If the scan 39 is set to a scan shift operation by a scan mode input, not shown, is possible to set an arbitrary value to the scan FF 39 thorough a shift operation. If the scan FF 39 is set to a capture operation, the scan FF 39 receives, as an output from the NOR 90, a logic operation result of input values from the first and second data inputs by the NOR 90.

In the present exemplary embodiment, the test point circuit employs a NOR circuit. In general, the number of transistors in a NOR circuit is one fifth of the number of transistors in a scan FF. Therefore, the test point circuit disposed on the memory core 57 according to the present exemplary embodiment can be realized with less transistors than the test point circuit disposed on the memory core 58 according to the second exemplary embodiment. The NOR circuit in the test point circuits 27, 28 can be replaced by a NAND circuit, an EX-OR circuit, an EX-NOR circuit, an OR circuit, or an AND circuit.

The scan test circuits according to the above first to third exemplary embodiments provide the following advantages, but not restricted thereto.

As a first advantage, time required for a delay fault test on a peripheral circuit of a memory with a built-in repair function can be reduced. The reason is as follows. The scan test circuit according to the present invention is an LSI circuit with a combinational circuit, scan FFs, a memory with a built-in repair function, and a repair control circuit, comprising: a test priority control circuit that outputs a control value for a state of the highest rank and a state of the lowest rank of the all possible combination in repaired states; and a test point circuit that is disposed within a memory core of the memory with a built-in repair function and includes a scan FF and an MUX (selector) at a data input side of the memory cell columns. The delay fault test on the memory peripheral circuit is performed using scan FFs and a scan FF within the test point circuit. The test is performed, respectively, in a state of the highest rank and in a state of the lowest rank of the all possible combinations in repaired states by the test priority control circuit. Since a scan FF disposed in the test point circuit is used without using the memory circuit, there is no need to use a sequential circuit algorithm and to fix a memory address of the memory circuit. It is possible to generate a test pattern, by which many faults can be detected. Therefore, the number of test patterns can be reduced and the test time can also be reduced.

As a second advantage, a test on a memory peripheral circuit that is connected to an enable input has been impossible in the conventional technology, a delay fault test on the circuit has become possible. The reason is as follows. An enable input signal is connected to data input of the test point circuit. The test is performed using the scan FF of the test point circuit. At least during the scan path capture operation (reading a data input value of the scan FF), the test point circuit outputs a value that keeps the memory circuit in a state in which it can read and write normally or in a state in which it can outputs its stored value. In this case, the output value from the test point circuit connected to the data input can be output from the output terminal of the memory circuit.

Within the entire disclosure of the present invention (including the claims), and based on its basic technological idea, exemplary embodiments or examples of the present invention may be changed and/or adjusted. Also it should be noted that in the framework of the claims of the present invention, any combinations or selections of various elements disclosed herein are possible. That is, needless to say, it is understood by those skilled in the art that various changes or modifications can be made to the present invention based on the disclosure of the present invention including the claims and the technological idea of the present invention.

What is claimed is:

1. A scan test circuit for a memory, said memory comprising:
a plurality of first memory cell columns,
a second memory cell column that replaces a failed column of the plurality of first memory cell columns,
a first switching circuit that connects one of the plurality of first memory cell columns and the second memory cell column to a first peripheral circuit disposed at an input side, and
a second switching circuit that connects one of the plurality of first memory cell columns and the second memory cell column to a second peripheral circuit disposed at an output side; said scan test circuit comprising:
a test priority control circuit that controls the first switching circuit and the second switching circuit to establish at least two patterns of connections between the plurality of first and second memory cell columns, and the first and second peripheral circuits; and
a test point circuit that includes scan flip-flop circuits employed in a scan test for detecting a delay fault of the first peripheral circuit and the second peripheral circuit, and is disposed between the plurality of first and second memory cell columns, and the first switching circuit.

2. The scan test circuit according to claim 1, wherein said test point circuit is adapted to a control signal for the memory.

3. The scan test circuit according to claim 2, wherein said control signal is an enable signal for the memory.

4. The scan test circuit according to claim 2, wherein said control signal is an address signal for the memory.

5. A semiconductor integrated circuit device, comprising the scan test circuit according to claim 1.

6. A scan test method for a memory, said memory comprising:
a plurality of first memory cell columns,
a second memory cell column that replaces a failed column of the plurality of first memory cell columns,
a first switching circuit that connects one of the plurality of first memory cell columns and the second memory cell column to a first peripheral circuit disposed at an input side, and
a second switching circuit that connects one of the plurality of first memory cell columns and the second memory cell column to a second peripheral circuit disposed at an output side; said scan test method comprising:
controlling the first switching circuit and the second switching circuit to establish at least two patterns of connections between the plurality of first and second memory cell columns, and the first and second peripheral circuits; and
performing a scan test for detecting a delay fault of the first peripheral circuit and the second peripheral circuit using: a scan flip-flop circuit within a test point circuit that is disposed between the plurality of first and second memory cell columns, and the first switching circuit; a scan flop-flop circuit connected to input of the first peripheral circuit; and a scan flip-flop circuit connected to output of the second peripheral circuit.

7. The scan test method according to claim 6, wherein said scan test is performed using a test pattern generated based on a combinational circuit algorithm.

8. The scan test method according to claim 6, wherein said scan test may be performed without fixing an address of the memory.
